(19) United States
(12) Patent Application Publication
(10) Pub. No.: US 2021/0379683 A1
(43) Pub. Date: Dec. 9, 2021

(54) Assembly and Method for Applying Solder Balls to a Substrate

(71) Applicant: Ghassem Azdasht, Berlin (DE)

(72) Inventor: Ghassem Azdasht, Berlin (DE)

(21) Appl. No.: 16/614,235

(22) PCT Filed: May 15, 2018
(86) PCT No.: PCT/EP2018/062571

§ 371 Date: Nov. 15, 2019

(30) Foreign Application Priority Data
May 18, 2017 (DE) 10 2017 110 830.0

(51) Int. Cl. B23K 3/06; B23K 1/005; B23K 1/00

(52) U.S. Cl. CPC B23K 3/0623; B23K 2101/40; B23K 1/0016; B23K 1/0056

(57) ABSTRACT

Assembly for placing solder from solder balls on a substrate, comprising a reservoir with a plurality of solder balls, an exit opening for releasing one single solder ball, a feeding channel between the reservoir and the exit opening with a feeding channel width larger than the diameter of one solder ball and smaller than the diameter of two solder balls, and a suction channel with end opening into the feeding channel which end is smaller than the diameter of one solder ball. A pressure difference is generated between the feeding channel and the suction channel and is controlled whereby pressure in the suction channel is smaller than in the feeding channel. A solder ball present in the feeding channel can be sucked to and held to the end of the suction channel at a first pressure difference to block feeding of solder balls and is released at a second pressure difference.

### TECHNICAL FIELD

The invention relates to an assembly for placing solder balls on a substrate, comprising
(a) a reservoir with a plurality of solder balls;
(b) an exit opening for releasing one single solder ball;
(c) a feeding channel provided between the reservoir and the exit opening for feeding solder balls from the reservoir to the exit opening.

Such an assembly is used particularly in the field of bonding of semiconductor circuits. In order to place as many connection points as possible in a small space and thereby be able to produce semiconductor circuits with small diameters, solder balls with small diameters are advantageous. Solder balls are used having diameters in the range below 100 μm, for example 40 μm. The handling of the small balls is difficult. It is not possible to simply take balls from the reservoir and place them on a substrate. The balls must be singled out and moved in a controlled manner.

### PRIOR ART

It is known to place solder balls from a reservoir on a disc in a circular pattern. The balls are moved to the connection point by rotating the disc. There they are placed on the substrate. A shutter device is provided for this purpose. After placing the ball, the disc is rotated further and the procedure is repeated as often as necessary.

Rotating the disc and accurate positioning is necessary between placing the balls. This is time consuming. There is a certain wear and tear of the assembly involved due to moveable parts. Furthermore, hard material must be used. Such material is expensive. Only one ball can be placed on the substrate using an assembly with a disc.

JP 2010-162574 A discloses an assembly for placing solder balls. The solder balls run through an L-shaped channel. A connector is provided at the kink of the channel where a pressure difference can be generated. Thereby, a ball can be sucked in at first. Thereafter, the ball is pushed upwards into a vertical leg of the channel behind the kink against gravity forces by individually exerting overpressure. With such an assembly there is the risk that the ball first sucked in will return back to the feeding channel. The manufacturing of such an assembly is complicated.

### DISCLOSURE OF THE INVENTION

It is an object of the invention to provide an assembly of the above mentioned kind which is more economical and which enables faster placement of the balls on a substrate. According to the invention, this object is achieved in that
(d) the feeding channel has an opening cross section with a diameter which is larger than the diameter of one of the used solder balls and smaller than the diameter of two of the used solder balls;
(e) a suction channel ending in the feeding channel and having a cross section in the transition range between the suction channel and the feeding channel which is smaller than the cross section of one of the used solder balls;
(f) means for generating a pressure difference between the feeding channel and the suction channel whereby the pressure in the suction channel is smaller than in the feeding channel and a solder ball present in the feeding channel can be sucked in at the transition range of the suction channel; and
(g) control means for controlling the pressure difference in such a way that at least one solder ball is held back at a first pressure difference at the transition range between the suction channel and the feeding channel and the feeding of further solder balls is blocked and is released with a second pressure difference.

With the assembly a ball can be held back in the feeding channel by generating a pressure difference between suction channel and feeding channel whereby the ball is sucked in by the suction channel. This can be achieved either by a lower pressure in the suction channel or by a higher pressure in the feeding channel or both. In the transition range between the feeding channel and the suction channel the suction channel has a smaller diameter than a ball. Therefore, the ball cannot enter the suction channel. It is fixed in the transition range. The feeding channel has a diameter which is large enough to enable the balls to freely move therethrough. The feeding channel has a diameter which is smaller than twice the diameter of a ball. The following ball, therefore, may not pass the fixed ball in the transition range. By shortly changing the pressure conditions to a small pressure difference or to zero pressure difference the fixed ball can be released. It will then move to the exit opening. The pressure difference is increased thereafter whereby the next ball is also fixed.

Contrary to known assemblies the assembly does not require moveable parts but can be controlled by controlling the pressure conditions only. This can be achieved much faster than the movement of part, such as, for example, a disc.

The process of singularizing out and controlling the movement of the balls is particularly advantageous when two, three or more suction channels are in the moving direction consecutively connected to the feeding channel and the control means are configured in such a way that the solder ball on the side of the exit opening can be released while at least one solder ball can be held back at one of the other suction channels. Thereby, the risk is avoided that one or more balls pass the transition range when the fixed ball is released. The ball fixed upstream in the feeding channel will hold back the other balls during the releasing process and block the feeding channel. With three or more suction channels with three or more transition ranges the balls can be consecutively fixed at the respective next suction channel. For this purpose the pressure difference at the suction channels can be lowered one after the other.

Preferably, the feeding channel is exposed to a gas pressure above atmospheric pressure. The feeding channel can be connected to a gas source with nitrogen or another inert gas having an increased pressure for this purpose. In particular, an inert gas prevents that the solder balls will oxidize or otherwise chemically react with its environment and cause cold solder joints. Alternatively, a negative pressure is provided at the suction channel.

In a particularly advantageous modification of the invention the suction channels are connected to the atmosphere and the control means comprise a shutter or a valve for establishing and interrupting the connection between the suction channel and the atmosphere. Each time when the shutter opens a pressure difference is generated between the pressures in the suction channel and in the feeding channel. Such a shutter or valve can be opened and closed very quickly. Accordingly, the solder balls can be placed very quickly. The suction channel may also end in another pressure chamber, such as, for example, with negative pressure, instead of towards the atmosphere.

Preferably, it is provided that the feeding channel ends in an exit channel wherein the exit channel is provided with an exit opening used to place the solder onto the substrate and a laser is provided emitting radiation which extends through the exit channel to the exit opening and where the radiation is configured such, that the solder of the solder ball is transferred onto the substrate by the impact of the radiation. The ball is, therefore, moved from the feeding channel to the exit channel. A laser beam extends through the exit channel to the exit opening. The solder ball can be molten by the laser beam and placed on the substrate.

Preferably, the feeding channel and the exit channel form an angle. The feeding channel, for example, can extend horizontally or nearly horizontally. With a slight downwards inclination of the feeding channel in the direction of the exit channel the ball will be exposed to gravity and roll towards the exit channel without exerting any further forces. The inclination in the range before the exit channel may be greater than in the rest of the range. The exit channel may be, for example, vertical or nearly vertical. The ball will then fall downwards towards the exit opening due to gravitational forces. A laser and/or deflecting- and/or focusing optical arrangement can be easily installed at the upper end of the angular assembly. A focusing optical arrangement, such as a lens, however, may also be installed at any of the other positions in the exit channel.

Very small channels must be produced for an assembly with very small balls. In a particularly advantageous modification of the invention a sheet assembly is provided with several plane sheets adapted to be laid one on the other and configured to be fixed in such position, wherein the feeding channel and the suction channels are formed by slits in the sheets of the sheet assembly. The sheets can be placed one on top of the other in such a way that the slits of the respective adjacent sheet are closed. The slits can be manufactured with high accuracy in the desired position and size in the sheets by means of a laser. Alternatively, the channels and boreholes are produced in one block, such as, for example, by using three-dimensional printing.

In a further modification of the invention the sheet assembly may comprise a feeding channel sheet with a feeding channel and an adjacent guiding sheet which is provided with a guiding slit in the range of the feeding channel for guiding the movement of the solder balls in the feeding channel, the guiding slit having a smaller width than the width of the feeding channel. Preferably, the guiding sheet is positioned below the sheet with the feeding channel. The ball will then run on the guiding slit like on a track. Thereby, it is ensured that the balls are moved in the center of the feeding channel and cannot accumulate or block.

Preferably the sheet assembly is provided with a first suction channel sheet adjacent to the feeding channel sheet, the suction channel sheet having boreholes which are positioned one next to the other in a line in the moving direction of the solder balls in the end range remote to the reservoir, the boreholes forming the transition range between the suction channel and the feeding channel and a second suction channel sheet on the side of the first suction channel sheet which is remote to the feeding channel sheet, the second suction channel sheet having slits, which connect the boreholes to the atmosphere or to a channel connected to the atmosphere. The boreholes in the first suction channel sheet are above the slit for the feeding channel, shortly before its end, when the sheets are assembled. They each end in different slits in the second suction channel sheet which is arranged above. The slits in the second suction channel sheet may optionally be connected. They end in an opening towards the atmosphere. However, it is also possible to extend the slits to the surface and to connect them to a vacuum chamber.

A further embodiment of the invention provides that the reservoir, the exit opening, the feeding channel and the suction channel are united in one module and at least one further equivalent module is provided, which together with the module forms a modular assembly, wherein the exit openings of the modules are positioned next to each other above the substrate. Contrary to an assembly with sheets the present assembly forms a compact block which is configured to be connected to further such blocks at their plane sides. In such a way several balls may be placed simultaneously on the substrate.

A plurality of such individually adjustable modules can be united in a modular assembly which can be adjusted as a whole.

Further modifications of the invention are subject matter of the subclaims. An embodiment is described below in greater detail with reference to the accompanying drawings.

### BRIEF DESCRIPTION OF THE DRAWINGS

FIG. 1 is a schematic view of a vertical cross section of an assembly for placing solder balls on a substrate.

FIG. 2a-d show embodiments of sheets of a sheet assembly which is used in the assembly of FIG. 1.

FIG. 3 illustrates the effects of a guiding slit in the sheet of FIG. 2d of the sheet assembly of FIG. 2.

FIG. 4 is a schematic representation of an exit channel in an assembly for placing solder balls according to FIG. 1.

FIG. 5 is a vertical cross section in a cross sectional plane A-A in FIG. 1 with a sucked in ball.

FIG. 6 is a vertical cross section in the cross sectional plane A-A in FIG. 1 with released ball.

FIG. 7 illustrates an assembly with a plurality of modules for placing several solder balls in the same time frame.

FIG. 8 is a schematic view of the solder balls placed on a substrate with a modular assembly with a plurality of modules.

FIG. 9 is a schematic view of the solder balls placed on a substrate with the modular assembly of FIG. 8 which was inclined about a horizontal axis.

FIG. 10 is a schematic view of the solder balls placed on a substrate with the modular assembly of FIG. 8 which was inclined about a vertical axis.

FIG. 11 illustrates how the distances between the solder balls vary when the modular assembly is inclined about a vertical axis.

FIG. 12 illustrates how the distances of the solder balls may be varied by inclining the modules of a modular assembly with respect to each other.

FIG. 13 illustrates the extent of an inclination of a module for adjusting a desired position.

### DESCRIPTION OF THE EMBODIMENTS

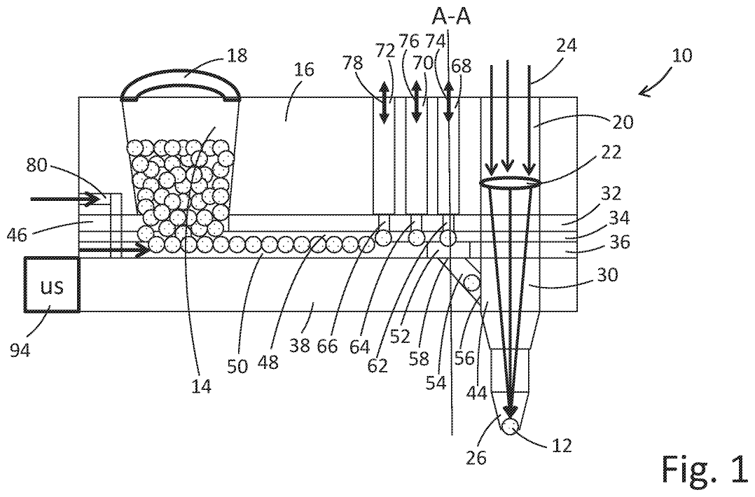

FIG. 1 is a schematic representation of a bond head generally designated with numeral 10. For better overview the bond head 10 is shown without the necessary control unit and mounting. One such bond head is placed above a substrate (not shown). Solder balls 12 from a reservoir 14 are singled out in the way described below and placed on the substrate. An example for such a substrate is a wafer.

The bond head 10 has a block 16. In the present embodiment the block 16 is made of aluminum. It is understood, however, that any other material may be suitable. It is not necessary to use expensive, hard materials. The block 16 is essentially cuboid-shaped, but may assume any other outer shape also, if this is useful.

A large cavity is provided in the block 16 serving as a reservoir 14. The reservoir 14 is tightly closed by a lid 18. The block 16 is furthermore provided with a wide through borehole 20. The through borehole 20 serves as a portion of an exit channel 30. A focusing lens 22 is arranged in the through borehole 20. The focusing lens 22 or a lens assembly serves to focus a laser beam 24 in the range of an exit opening 26. The laser beam 24 serves to melt a soldering ball present in the exit opening.

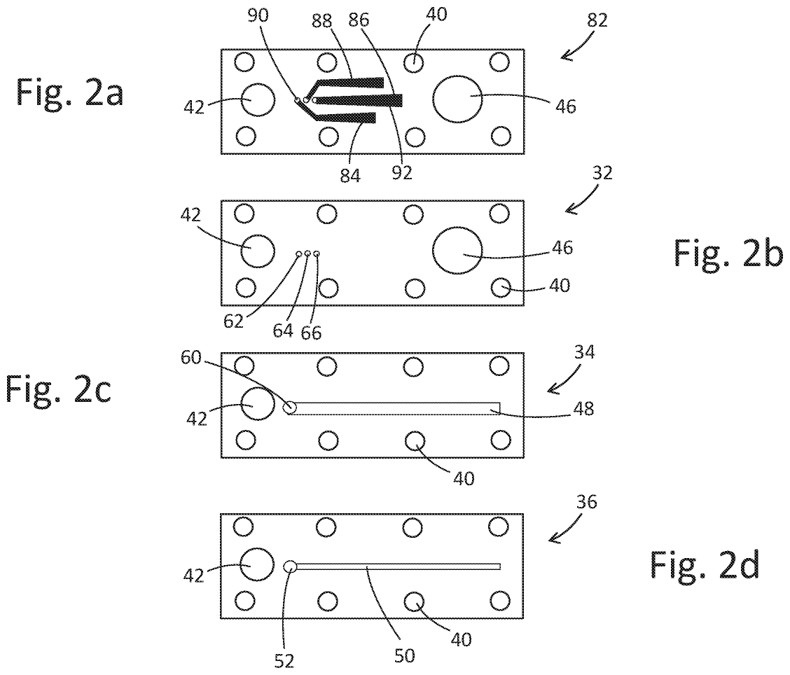

The block 16 is connected to a sheet assembly of a plurality of stacked sheets 32, 34 and 36. The sheets 32, 34 and 36 are separately shown in FIGS. 2b, 2c and 2d. The sheet assembly with the sheets 32, 34 and 36 sits between the block 16 and a base 38. All parts can be made of aluminum or any other suitable material. For fixing purposes the block 16 and the sheets of the sheet assembly are provided with boreholes 40 along their edge, which can be well recognized in FIG. 2. Ten boreholes 40 are provided in the present embodiment. A screw can be inserted through such boreholes which is tightly screwed into a threaded bore in the base. The head of the screw can be sunk in a recess in the block 16.

The sheets 32, 34 and 36 are each provided with a borehole 42. The borehole 42 of each sheet is aligned with the corresponding boreholes 42 in the other sheets and the through-borehole 20. Together with a corresponding borehole 44 in the base 38 they form a portion of the exit channel 30.

Furthermore, the sheet 32 is provided with a wide borehole 46. The borehole 46 is aligned with the cavity forming the reservoir 14 and has about the same diameter. This can be well recognized in FIG. 1. A slit 48 is provided in the sheet 34. The slit 48 forms a portion of a feeding channel guiding the balls 12 from the reservoir 14 to the exit opening 26. The slit 48 extends from below the borehole 46 up to shortly before the range of the borehole 42. The width of the slit 48 is larger than the width of one of the used balls 12 from the reservoir 14. The balls may then well move through the slit 48. The width of the slit 48, however, is small enough to prevent a second ball 12 passing another ball. In such a way only one ball 12 can be moved along one position through the slit 48. Consequently, the balls 12 individually run through the slit 48 one after the other.

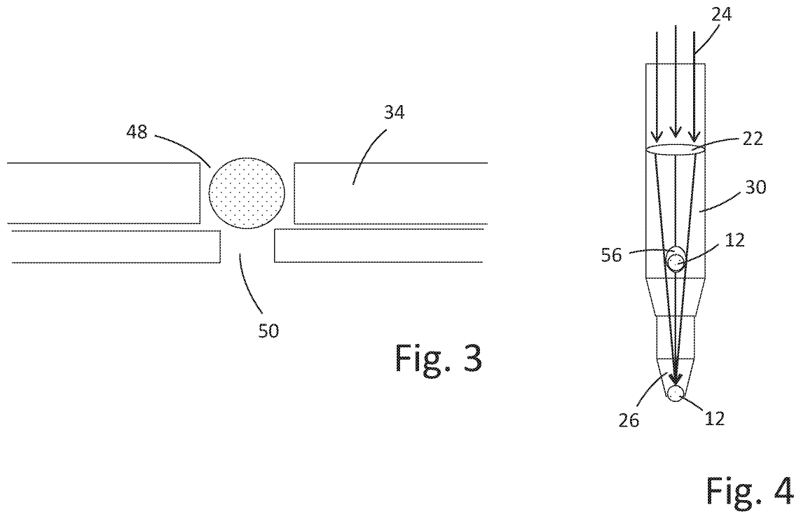

In the present embodiment the balls 12 are guided in the center of the slit 48. For this purpose a slit 50 having about the same length is provided in the sheet 36 which is arranged therebelow. The slit 50 has a smaller width than a diameter of a ball 12. This can be well recognized in FIG. 3. The ball 12 can, therefore, not enter into the slit 50 but is guided thereon like on a track. Thereby, the balls 12 consecutively run on the slit 50 in the feeding channel which is formed by slit 48 as it is schematically shown in FIG. 1. At the end 52 remote from the reservoir 14 the slit 50 is circularly widened. The widening is larger than the diameter of a ball 12. The ball 12, therefore, can move downwards through the widening 52. Such a widening 60 can also be provided at the end of slit 48. Thereby, the downward movement is facilitated.

A connecting channel 54 is provided in the base 38, the connecting channel 54 having the shape of an inclined borehole. This can be particularly well recognized in FIG. 1. The connecting channel 54 connects the widening 52 and the slit 48 above it and the widening 60, respectively, with the through borehole 44. The connecting channel 54 is wider than the diameter of a ball 12, whereby it can move from the feeding channel 48 through the widenings 60 and 52 and the connecting channel 54 to the exit channel 30.

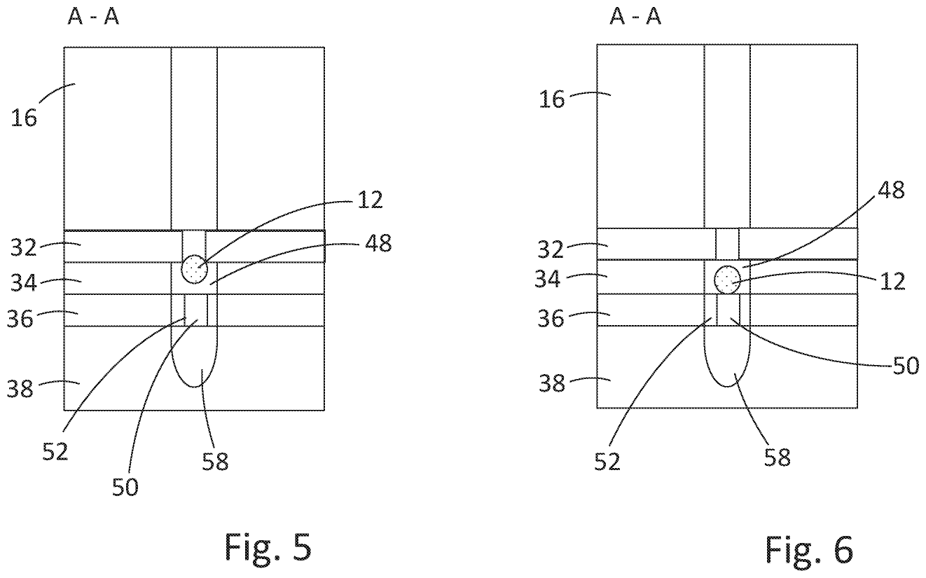

FIG. 4 shows a cross section through the exit channel 30 along a vertical cross sectional plane which is rotated relatively to the cross sectional plane in FIG. 1 by an angle of 90 degrees. The end range 56 of the connecting channel 54 before the exit channel 30 with a ball 12 can be recognized. FIG. 5 and FIG. 6 show a cross section which is laterally shifted in a longitudinal direction of the slits 48 and 50. The inlet range 58 of the connecting channel 54 can be recognized. The position of the widening 52 can be recognized in FIGS. 5 and 6 which is aligned with the inlet range 58.

Sheet 32 lays on the sheet 34 with the feeding channel 48. The sheet 32 is provided with three boreholes 62, 64 and 66 having a diameter which is smaller than the diameter of the used balls 12. This can be recognized in FIG. 1. The boreholes could not be well recognized in FIG. 2b when shown up to scale and are, therefore, shown with increased scale. The boreholes 62, 64 and 66 lay in series shifted in the longitudinal direction above the slit 48. The borehole 62 is provided on the side of the slit 48 remote from the reservoir 14 above the widened ranges 60 and 52 of the slits 48 and 50. The boreholes 64 and 66 are shifted in a longitudinal direction in the range above slits 48 and 50 closer to the reservoir 14.

FIG. 1 is a schematic representation. There, the boreholes 62, 64 and 66 end in vertical through boreholes 68, 70 and 72 in block 16. The through boreholes 68, 70 and 72 connect the boreholes 62, 64 and 66, respectively, to the atmosphere. A controllable valve or a shutter (not shown) control the connection to the atmosphere. This is represented by arrows 74, 76 and 78.

The block 16 is provided with a lateral borehole 80. The borehole 80 ends inside in the range of the slits 48 and 50 and in the range of the borehole 46. A gas source with inert gas, such as nitrogen, is connected to the borehole 80. The gas provides an increased pressure. In such a way the entire interior of the assembly, including the reservoir 14 which is closed by lid 18, the slits 48 and 50, the boreholes 62, 64, 66, 68, 70 and 72 and the borehole 54 are exposed to an increased pressure. If a valve opens towards the atmosphere in one of the boreholes 68, 70 or 72 a pressure difference is generated. The pressure in the slits 48 and 50 is higher than the pressure in the boreholes. Accordingly, a suction effect is generated. A ball in the feeding channel is sucked in upon passing a borehole with opened valve.

The diameters of the feeding channel formed by slit 48 are selected such that a ball 12 cannot pass any other ball. If, therefore, a ball 12 is fixed at a borehole 62, 64 or 66 due to the suction effect no balls may pass. The passage in the feeding channel is fully blocked. FIG. 1 schematically shows the situation where a ball is fixed at each of the boreholes 62, 64 and 66.

The manufacturing of the channels 68, 70 and 72 as shown in the schematic view in FIG. 1 is difficult. The boreholes 62, 64 and 66 have a very small diameter and are close together. The manufacturing can be facilitated by adding another sheet 82 laying on sheet 32. The sheet 82 also has boreholes 40, 42 and 46 as described above already with respect to the other sheets. Furthermore, the sheet 82 has three slits 84, 86 and 88. Slit 84 ends at its exit side end 90 in the range above the borehole 62. Slit 86 ends at its exit side end 90 in the range above the borehole 64. Slit 88 ends at its exit side end 90 in the range above the borehole 66. The exit side ends 90 of slits 84, 86 and 88 are relatively small whereby they do not extend to the range above the adjacent borehole. Otherwise, however, the slits 84, 86 and 88 are widening. Analogously to the boreholes 68, 70 and 72 the base 16 has boreholes which are slightly wider and extend either from the side or from above to the other end 92 of the slits 84, 86 and 88 on the side of the atmosphere. Such slits can be easily manufactured with a laser in a sheet. An ultrasound vibrator 94 serves to move the assembly with high frequency. The movability of the balls 12 is improved with the vibrator 94. They will not be jammed or block.

The assembly operates as follows:

Solder balls 12 can be filled into the reservoir 14 when the lid is open. Then the reservoir 14 is tightly closed with the lid. The balls 12 fall downwards through boreholes 46 into the slit 48. There they will move towards the right. FIG. 1 shows the assembly where the feeding channel 48 is essentially horizontal. The movement is caused by a pressure drop. In order to improve the movement of the balls in the direction of the exit opening the feeding channel 48 may also be slightly inclined downwards in the direction of the exit opening. This can be achieved by a wedge-shaped sheet or by inclining the entire assembly. The balls 12 are guided by the slit 50 in the center of the feeding channel 48 as can be well recognized in FIGS. 3 and 6.

At first, all valves towards the atmosphere are open. In the transition range between feeding channel 48 and borehole 62, 64 and 66 balls 12 are sucked in due to the pressure difference. Thereby, they block the passage for following balls, as can be well seen in FIG. 1.

If the valve at channel 68 is closed the ball is released by the bore hole 62. It will fall into the connecting channel 54 due to gravity. From the connecting channel 54 the ball 12 will fall into the exit channel 30. At first, the ball will be stuck in the exit opening 26. Thereby, the exit opening 26 is closed. An increased pressure builds up in the exit channel 30 and in the connecting channel 54. A pressure sensor (not shown) measures the pressure in the connecting channel 54. The pressure increase in the connecting channel 54 indicates that a ball is present in the range of the exit opening 26.

When the ball 12 reaches the exit opening 26 the valve in the borehole 68 opens. The valve in the borehole 70 closes. Thereby, the middle one of the fixed balls is released. It is sucked in at the next borehole 68 and fixed. Then the valve at the borehole 70 is opened again and the valve in the borehole 72 is closed. The ball which has been fixed before the reservoir-side borehole 66 is released and sucked in by the middle borehole 64 and fixed there. When the valve in the borehole 72 is opened again a new ball from the feeding channel 48 is fixed before the borehole 66. This will block the movement of following balls. In such a way only one ball is moved to the exit opening 26 at a time.

A laser beam 24 is focused in the exit channel 30 with a lens 22 or a lens assembly. The ball in the exit opening 26 sits in the focus of the laser beam 24. The energy of the laser beam is selected such that the ball 12 will melt and the solder is placed on a substrate present therebelow. It is understood that the exit opening is positioned exactly at such position where the solder shall be used. The assembly does not use moveable parts. The speed for placing the solder balls is, therefore, only limited by the closing times of the valves. They are much smaller than the time required for moving a disc or the like.

An IR-sensor measures the temperature of the solder. In such a way the laser activity can be controlled. A semi-transparent mirror is provided for this purpose for coupling in the laser radiation from the side into the exit channel 30. The semi-transparent mirror will transmit IR radiation upwards. The laser can be an IR- or VIS-laser.

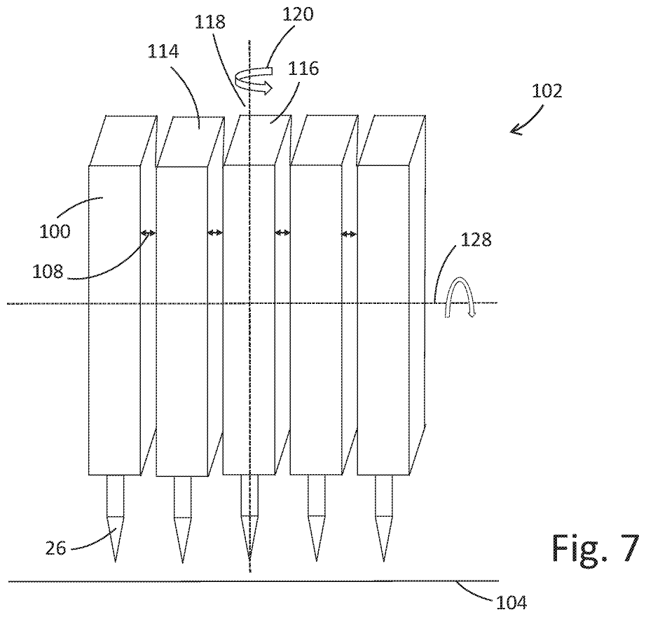

In the present embodiment an assembly was selected which as a whole essentially forms a cuboid modular block 100. Only the exit opening 26 is provided in a downwardly extending tip. This enables to arrange several such modules 100 next to each other as it is schematically illustrated in FIG. 7. The modular assembly 102 formed in such a way can be moved along the substrate 104 or the substrate 104 is moved below the modular assembly 102.

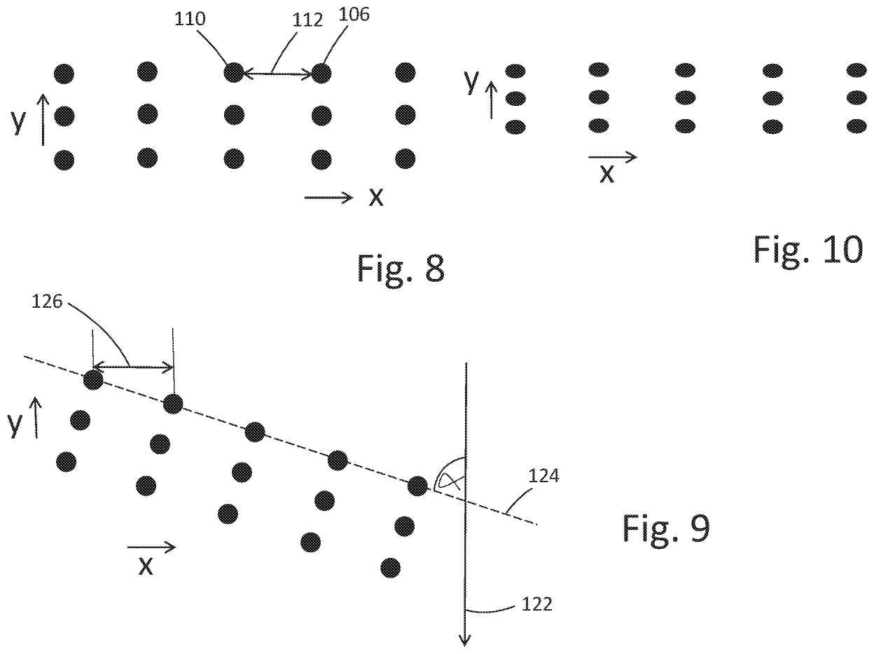

FIG. 8 shows a pattern which is generated when each module 100 simultaneously places a solder ball on the substrate. It is understood, that by suitable time controlling of each module the position of the contact points 106 can be shifted in the desired way in y-direction, i.e. in the direction of the movement of the substrate 14 or the modular assembly 102.

With the modular assembly the distances of the contact points are adjustable in x-direction also. A distance 112 between two contact points 106 and 108, for example, is determined by the distance of the exit openings of the corresponding modules 114 and 116. The exit openings are in the front range of the modules 114 and 116. If the modules 114 and/or 116 are rotated about a vertical axis by a small angle, the modules 114 and 116 form an angle. Thereby, the distance 108 between the modules varies in the range of the respective exit openings.

The angular range enabling such individual angular movements of the module about a vertical axis is limited in compact modular assemblies. Therefore, with small distances between the modules 100 it is, depending on the circumstances, not possible to cover all ranges. Therefore, it is provided with the present assembly to configure the entire modular assembly to be rotated about a common axis 118. This is illustrated by an arrow 120. Upon rotation about this axis 118 the exit openings 26 will not be aligned in a row 124 perpendicular to the direction of the movement. Instead the row 124 of the exit openings will form an angle α with the direction of the movement 122 of the substrate 104 or the modular assembly which is not 90°. This is illustrated in FIG. 9. Thereby, the distance 126 between the contact points is decreased with respect to the maximum distance 112 as illustrated in FIG. 8 by way of example.

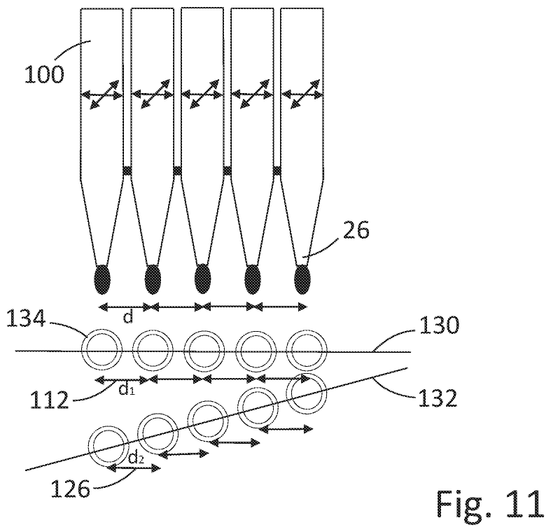

The Effect of such a rotation is shown in FIG. 11 again in greater detail. Several exit openings 26 are aligned in one row, which is represented by a line 130. The solder balls 134 laying in this row have a distance 112 designated by d₁. If the modular assembly is rotated by an angle as can be recognized in FIG. 7 the solder balls are aligned in a row 132. The distance 126 in the direction of d now designated as d₂ is smaller than d₁.

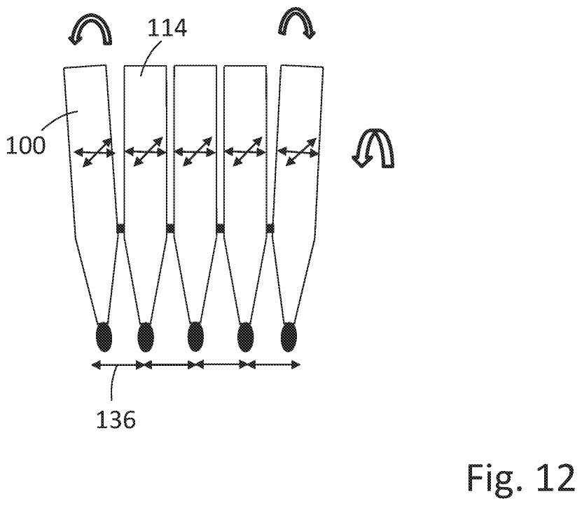

The rotation of the entire modular assembly causes all distances to be varied in the same way. However, it is also possible to incline individual modules with respect to each other. FIG. 12 illustrates by way of example, how the distance 136 is decreased by inclining the module 100 from the vertical plane about a horizontal axis perpendicular to the plane of representation with respect to the module 114.

It can be recognized that by suitably directing the modular assembly as a whole in space and by directing the individual modules amongst each other and adaption of the position of the contact points is possible. Contrary to known assemblies large areas of the substrate can be loaded practically simultaneously with solder.

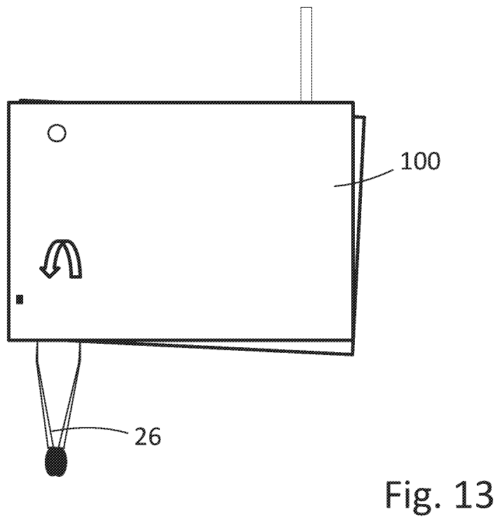

A rotation of the entire modular assembly about a horizontal axis 128, as shown in the side view of FIG. 13, enables small distances between the contact points with the same time resolution. This is illustrated in FIG. 10.

It is understood that not only modular assemblies may be used where only one row of modules is used. In the same way a plurality of modules can be arranged in series in the direction of the movement whereby entire areas of the substrate can be fed simultaneously.

1. An assembly for placing solder from solder balls on a substrate, comprising:
a reservoir with a plurality of solder balls, said solder balls having a diameter;
an exit opening for releasing one single solder ball of said plurality of solder balls;
a feeding channel provided between said reservoir and said exit opening for feeding solder balls from said reservoir to said exit opening
and wherein
said feeding channel has an opening cross section with a diameter which is larger than said diameter of one of said solder balls and smaller than twice said diameter of said solder balls;
a suction channel ending in said feeding channel and a transition range between said suction channel and said feeding channel, said suction channel having a cross section in said transition range which is smaller than said cross section of one of said solder balls;
said suction channel and said feeding channel are exposed to pressure and means for generating a pressure difference between said pressure in said feeding channel and said pressure in said suction channel whereby said pressure in said suction channel is smaller than said pressure in said feeding channel causing one of said solder balls present in said feeding channel can to be sucked in at said transition range of the suction channel; and
g) control means for controlling said pressure difference in such a way that at least one of said solder balls is held back at a first pressure difference at said transition range between said suction channel and said feeding channel and feeding of further of said solder balls is blocked and said at least one of said solder balls is released with a second pressure difference.

2. The assembly of claim 1, and wherein said feeding channel defines a moving direction for a movement of said solder balls and two, three or more suction channels are consecutively connected to said feeding channel in a line along said moving direction of said solder balls and said control means are configured in such a way that said one of said solder balls on the a side of said exit opening can be released while at least one of said solder balls can be held back at one of said two, three or more suction channels.

3. The assembly of claim 1, and wherein said feeding channel is exposed to a gas pressure above atmospheric pressure.

4. The assembly of claim 1, and wherein said feeding channel is connected to a gas source with nitrogen or another inert gas having an increased pressure for this purpose.

5. The assembly of claim 3, and wherein said suction channels are connected to atmosphere and said control means comprise a shutter or a valve for establishing and interrupting said connection between said suction channel and said atmosphere.

6. The assembly of claim 1, and wherein said feeding channel ends in an exit channel wherein said exit channel is provided with an exit opening used to place solder onto said substrate and a laser is provided emitting radiation which extends through said exit channel to said exit opening and where said radiation is configured such that solder of said solder ball is transferred onto said substrate by an impact of said radiation.

7. The assembly of claim 1, and wherein a sheet assembly is provided with several plane sheets adapted to be laid one on another and configured to be fixed in such position, wherein said feeding channel and said suction channels are formed by slits in said sheets of said sheet assembly.

8. The assembly of claim 1, and wherein said sheet assembly comprises a feeding channel sheet with said feeding channel, said feeding channel having a width and wherein said sheet assembly comprises an adjacent guiding sheet which is provided with a guiding slit in the range of said feeding channel for guiding said movement of said solder balls in said feeding channel, said guiding slit having a smaller width than the width of said feeding channel.

9. The assembly of claim 7, and wherein said sheet assembly is provided with a first suction channel sheet adjacent to said feeding channel sheet, said suction channel sheet having boreholes which are positioned one next to the other in a line in said moving direction of said solder balls in an end range remote to said reservoir, said boreholes forming said transition range between said suction channel and said feeding channel and a second suction channel sheet on a side of said first suction channel sheet which is remote to said feeding channel sheet, said second suction channel sheet having slits connecting said boreholes to atmosphere or to a channel connected to atmosphere.

10. The assembly of claim 1, and wherein said reservoir, said exit opening, said feeding channel and said suction channel are united in one module and at least one further, equivalent module is provided which together with said module forms a modular assembly, wherein said exit openings of said modules are positioned next to each other above said substrate.

11. The assembly of claim 10, and wherein said modules are positioned remote to each other and said position of at least one of said modules can be adjusted relative to an axis which is perpendicular to said substrate plane.

12. The assembly of claim 10, and wherein said position of said modular assembly is configured to be adjusted relative to an axis which is perpendicular and/or parallel to said substrate plane.
